(19) United States
(12) Patent Application Publication
(10) Pub. No.: US 2017/0297644 A1
(43) Pub. Date: Oct. 19, 2017

(54) SYSTEMS AND METHODS FOR A HANDLEBAR INTERCONNECTOR

(71) Applicant: NITE IZE, INC., Boulder, CO (US)

(72) Inventors: Bowden ORMSBEE, Boulder, CO (US); Rex W. STEVENS, Longmont, CO (US)

(21) Appl. No.: 15/640,705

(22) Filed: Jul. 3, 2017

Related U.S. Application Data
(63) Continuation of application No. PCT/US2016/012041, filed on Jan. 4, 2016.
(60) Provisional application No. 62/099,956, filed on Jan. 5, 2015.

(51) Int. Cl. B62J 11/00; B62J 6/02; B62K 21/12

(52) U.S. Cl. CPC B62J 11/00; B62J 6/02; B62K 21/12

(57) ABSTRACT

A handlebar mount includes a first side body and a second side body; and a central body, the central body interconnecting the first and second side bodies. The handlebar mount further includes a first elastic portion and a second elastic portion, oriented on the first and second side bodies, respectively. The handlebar mount further includes a first hook and a second hook, the first and second hooks oriented to receive the first and second elastic portions, respectively, and hold them securely.

### CROSS REFERENCE TO RELATED APPLICATION

This application is a continuation of co-pending International Application No. PCT/US2016/012041, filed Jan. 4, 2016, which is incorporated herein by reference in its entirety, and additionally claims priority from U.S. Application No. 62/099,956, filed Jan. 5, 2015, which is also incorporated herein by reference in its entirety.

### TECHNICAL FIELD

Embodiments described herein generally relate to systems for connecting headlamps to handlebars.

### BACKGROUND

It is desirable to provide for a headlamp or other lighting device (or other device) to connect to the handlebars of a bike or motorized vehicle having handlebars.

Headlamps are popular for many activities that take place in low light situations. Some examples include hiking in the early morning or at night, as well as fishing, hunting, and a variety of other activities that may take place at night or in the early morning. In numerous situations, a user may desire an adjustable headlamp for lighting areas in a hands-free manner. It is desirable that the direction of the light be adjustable as well.

### SUMMARY

In one embodiment, a handlebar mount includes a first side body and a second side body; and a central body, the central body interconnecting the first and second side bodies. The handlebar mount further includes a first elastic portion and a second elastic portion, oriented on the first and second side bodies, respectively. The handlebar mount further includes a first hook and a second hook, the first and second hooks oriented to receive the first and second elastic portions, respectively, and hold them securely. Optionally, each of the first and second side bodies includes a semi-circular area. Alternatively, the first and second elastic portions are oriented to stretch over the semi-circular area of each of the first and second side bodies when the first and second elastic areas are engaged with the first and second hooks. In one alternative, the handlebar mount has a first configuration and a second configuration when the handlebar mount is placed on handlebars, the first configuration characterized by the first and second elastic portions not engaging the first and second hooks, and the second configuration characterized by the first and second elastic portions engaging the first and second hooks, respectively. In another alternative, in the second configuration, the handlebars are located in the semi-circular area of each of the first and second side bodies and the first and second elastic portions apply tension to the handlebars, thereby holding the handlebar mount in place. In another alternative, first and second hooks are oriented on the central body. Optionally, the first and second hooks are oriented on the first and second side bodies, respectively. Alternatively, a first aperture and a second aperture are located at an end of each of the first and second elastic areas. In one configuration, each of the first and second side bodies includes a pin. Optionally, the central body portion includes a geared section. Alternatively, the pin on the first and second side bodies is cross-shaped and the pin and geared section hold a lighting module in a stationary position in relation to the handlebar mount. In one configuration, the handle bar mount further includes a lighting module mounted pivotally on the pin on each of the first and second side bodies. Alternatively, the central body includes a flexible tab that interacts with a geared section on the lighting module providing for the lighting module to be held in a variety of rotational positions. Optionally, the first and second side bodies are approximately triangularly shaped. In another alternative, each of the first and second side bodies includes a receiver section for receiving an insertable side portion of the central body. Optionally, the flexible tab is positioned such that the tab interfaces with the geared section, the flexible tab ratcheting from one groove to another groove of a plurality of grooves of the geared section, and the flexible tab flexing to allow the flexible tab to pass over the protrusions of the geared section.

In one embodiment, a method of mounting a device on handlebars includes providing a handlebar mount, the handlebar mount including: a first side body and a second side body and a central body, the central body interconnecting the first and second side bodies. The handlebar mount further includes a first elastic portion and a second elastic portion, oriented on the first and second side bodies, respectively. The handlebar mount further includes a first hook and a second hook, the first and second hooks oriented to receive the first and second elastic portions, respectively, and hold them securely. Each of the first and second side bodies include a semi-circular area, and the first and second elastic portions are oriented to stretch over the semi-circular area of each of the first and second side bodies when the first and second elastic areas are engaged with the first and second hooks. The method further includes placing the handlebar mount on handlebars, wherein the semi-circular area contacts the handlebars. The method further includes stretching the first and second elastic portions around the handlebars to the first and second hooks, respectively, and engaging them with the first and second hooks. The method further includes holding the handlebar mount on the handlebars with tension from the first and second elastic portions. Optionally, the handlebar mount includes a first aperture and a second aperture located at an end of each of the first and second elastic areas, and the method further includes placing the first and second hooks in the first aperture, and tightening the handlebar mount by stretching the first and second elastic portions to engage the first and second hooks in the second aperture. In this scenario, the second aperture is closer to the first and second elastic portions than the first aperture. Optionally, each of the first and second side bodies includes a pin, and the central body portion includes a geared section. Alternatively, a lighting module is mounted pivotally on a pin on each of the first and second side bodies. In one alternative, the method additionally includes rotating the lighting module on the handlebar mount by ratcheting a flexible tab that interacts with a geared area on the back of the lighting module, providing for the lighting module to be held in a variety of rotational positions.

### BRIEF DESCRIPTION OF THE DRAWINGS

FIG. 1 shows a perspective view of one embodiment of a handlebar mount;

FIG. 2 shows the handlebar mount of FIG. 1 including an exemplary lighting module;

FIG. 3 shows a perspective view of a side body of the handlebar mount of FIG. 1;

FIG. 4 shows a detailed view of a side cutaway view of the positioning of pin and gearing of the handlebar mount of FIG. 1;

FIG. 5 shows an assembled cross-section of the handlebar mount of FIG. 1;

FIG. 6 shows a front perspective view of the handlebar mount of FIG. 1 engaged with a cylindrical object;

FIG. 7 shows a bottom perspective view of the handlebar mount of FIG. 1 engaged with a cylindrical object; and

FIG. 8 shows a perspective view of another embodiment of a handlebar mount.

### DETAILED DESCRIPTION OF THE DRAWINGS

Described herein are embodiments of systems and methods for a handlebar mount. The handlebar mount is designed to accommodate a headlamp or other lamp that may be mounted on a handlebar.

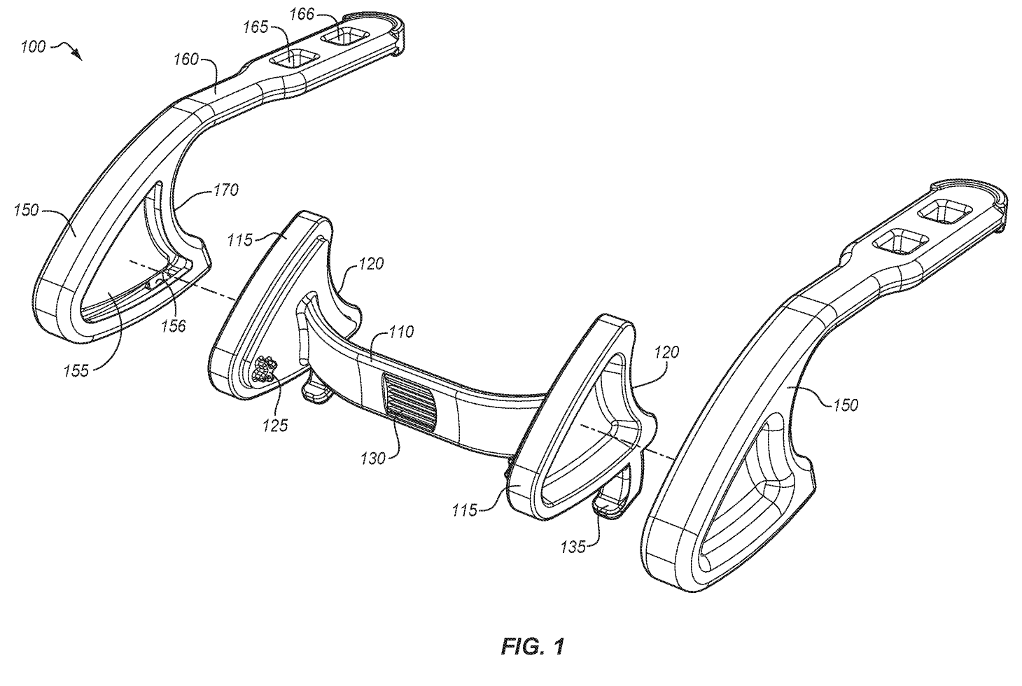

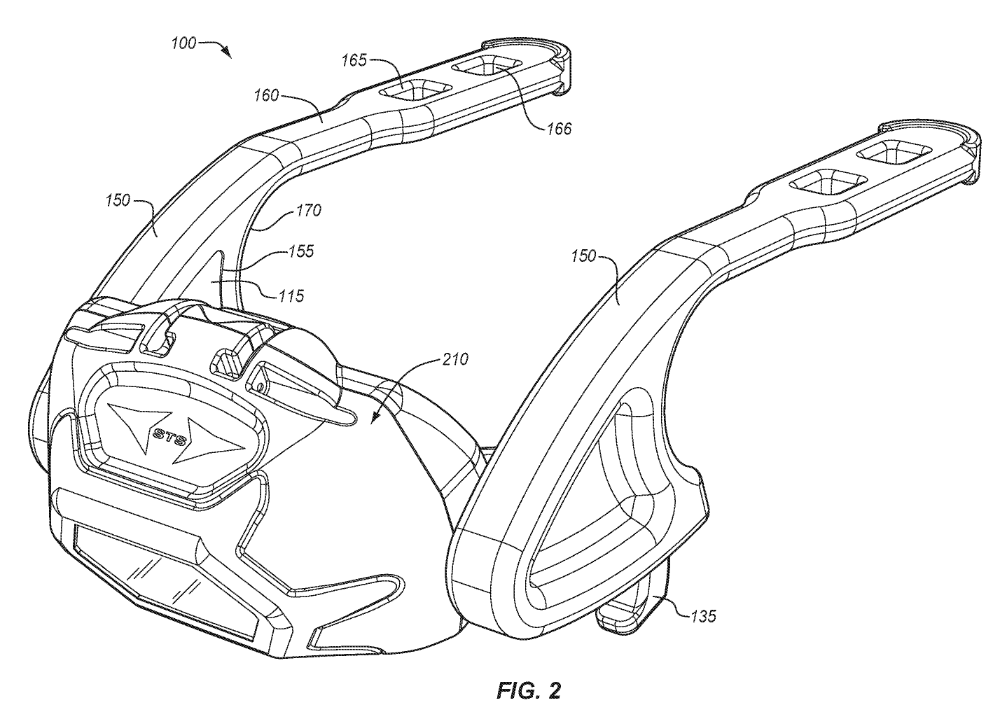

FIG. 1 shows one embodiment of a handlebar mount 100. Although the device is designed to be mounted on the handlebars of a bike or other motorized or non-motorized vehicle, it may be mounted on a variety of other structures. The handlebar mount 100 is designed to accommodate a lighting device, as will be explained. In many embodiments, the lighting device is a lighting module 210 (shown in FIG. 2) that may also be used in a headlamp. The design of the handlebar mount 100 may be modified to accommodate a variety of lighting devices.

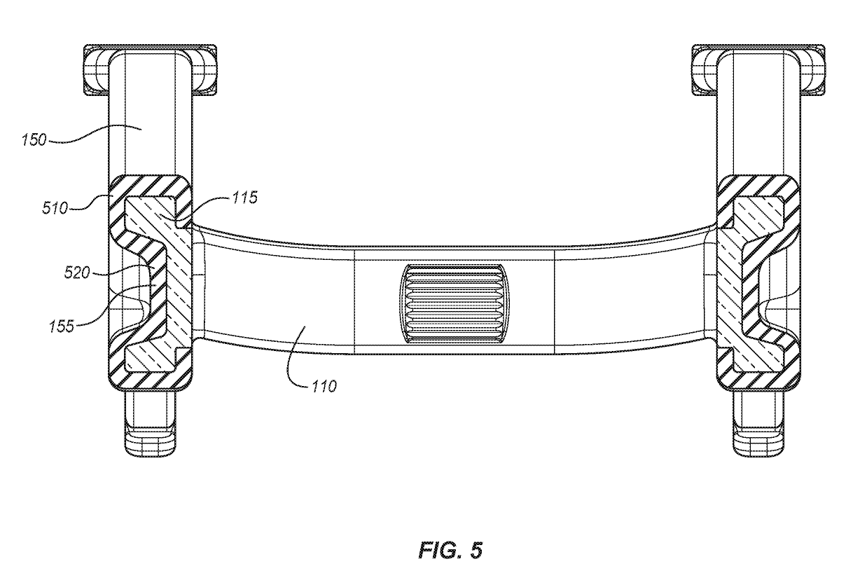

The handlebar mount 100 includes three parts: a center body 110 and a left side body and a right side body 150. Center body 110 includes two insertable side portions 115 that are sized and shaped to fit into receiver 155 in left and right side bodies 150, respectively. The receiver 155 in left and right side bodies 150 includes a hole 156 for receiving hook 135. FIG. 5 shows additional detail in a cutaway view. Both the side bodies 150 and the center body 110 include curved portions 120, 170 that are shaped to fit on a curved surface. In many uses, the curved surface will be handlebars. Curved portion 120 does not actually contact a curved surface and instead is shaped to fit into the receiver 155.

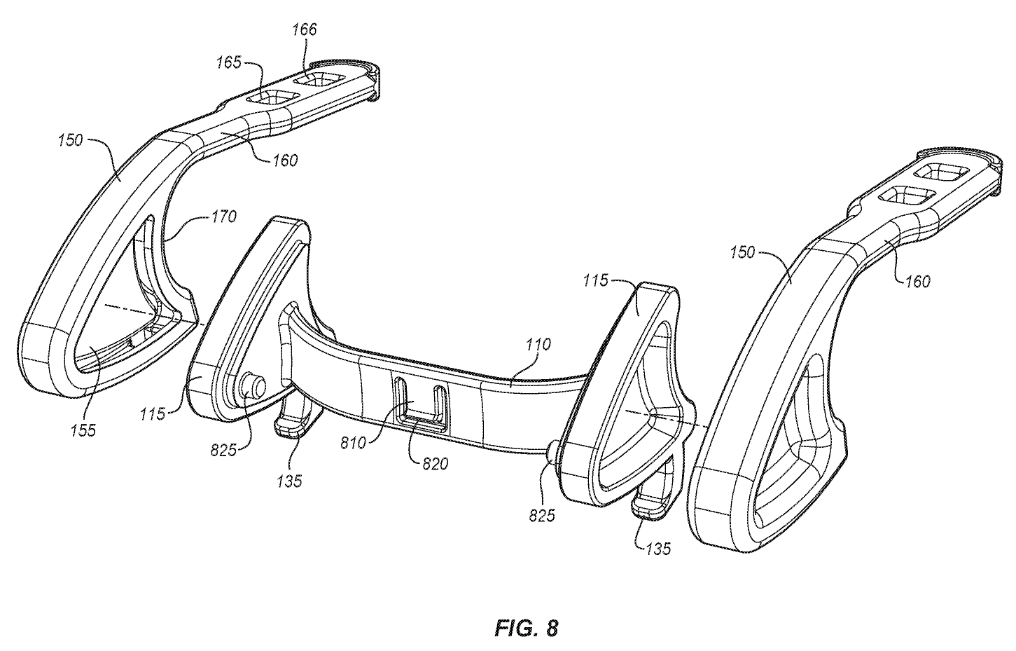

Center body 110 includes pins 125 and gearing 130 as well. Lighting module 210 is designed to fit on pins 125 and also includes a reciprocal gearing on the lighting module 210 for interacting with gearing 130. The design of gearing 130 and pins 125 provides for holding lighting module 210 in a fixed position. FIG. 8 describes a rotatable orientation below.

In order to connect the handlebar mount 100 to an object such as handlebars, curved portion 170 is placed along the handlebars. Elastic portion 160 is made of a material that will stretch when tension is applied to it. Hook 135 is oriented to receive apertures 165, 166. The length and stretchiness of elastic portion 160 and the position of apertures 165, 166 is designed to fit typically-sized handlebars, although any length and any positioning can be used depending on the object that the creator desires to have the handlebar mount 100 wrap around. The stretching of elastic portion 160 provides for a continued tension after hooking the apertures 165, 166 on hook 135; thus, holding the handlebar mount 100 firmly in place.

In many configurations, it is necessary to create two stable pivot points that the lighting module 210 may span. Right side and left side bodies 150 have been found to provide a high level of support in a triangular arrangement, as shown in the figures. Central body 110 provides for torsional stability, and the tension provided by elastic portion 160 provides for a solid connection to the handlebars.

Additionally, a high level of adaptability is provided by the handlebar mount 100, since it can connect to a wide variety of handlebars regardless of whether they are straight or curved, as well as a wide variety of widths.

FIG. 2 shows a fully assembled handlebar mount 100. Also shown is lighting module 210.

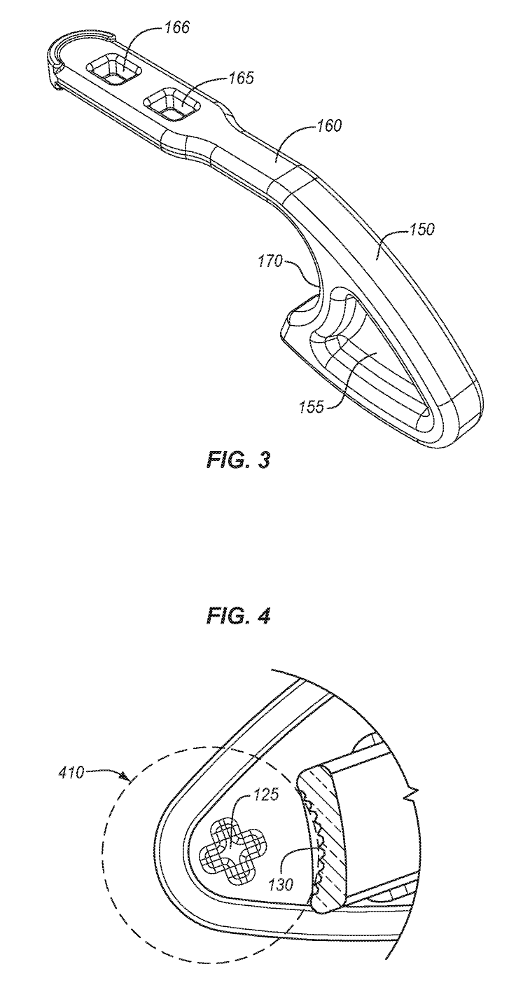

FIG. 3 shows a perspective view of a side body 150.

FIG. 4 shows a detailed view of a side cutaway view of the positioning of pin 125 and gearing 130. Pin 125 provides a center point for rotation of an object having a circular profile 410 extending to gearing 130. A portion of the object, in this case lighting module 210, includes such a circular profile.

FIG. 5 shows an assembled cross-section of the handlebar mount 100. Here, the interaction between the central body 110 and the side bodies 150 is visible. Central body 110 and insertable side portions 115 include a depressed area 510 and an extended area 520 that match the corresponding area in receivers 155. These extension and depression areas provide for a better interconnection between parts. The central body 110 and the side bodies 150, in many configurations, may be glued together after joining them.

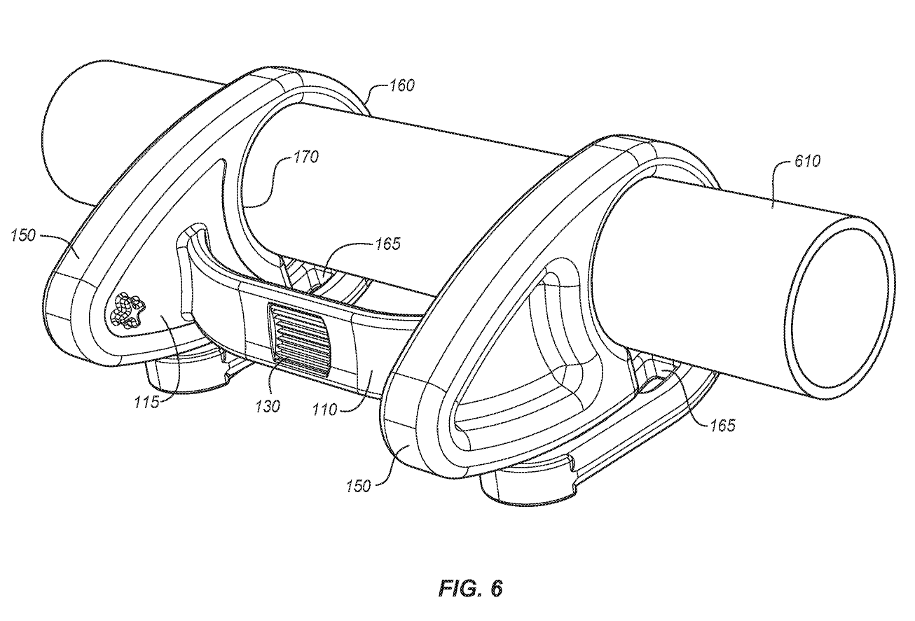

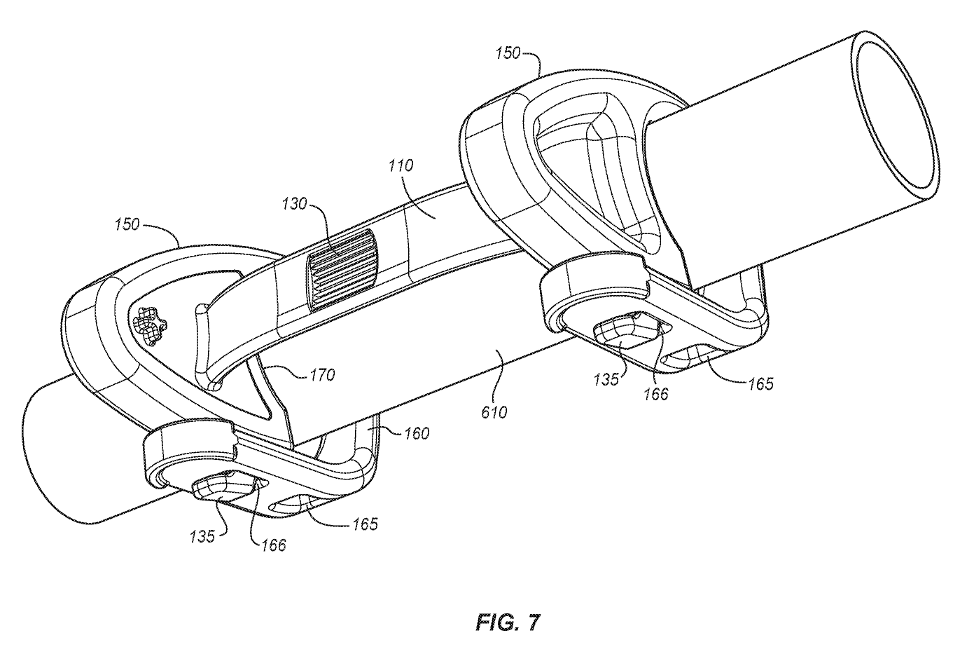

FIGS. 6 and 7 show additional detail as to how the handlebar mount 100 may attach to a cylindrical object 610. In alternatives, the cylindrical object need not be perfectly cylindrical for attachment. As shown, curved portion 170 rests on the corresponding curved portion of the cylindrical object 610 (such as handlebars). Elastic portion 160 stretches around cylindrical object 610. Apertures 166 or 165 may be hooked on hook 135 as clearly shown in FIG. 7. What aperture is chosen depends on the thickness of the cylindrical object 610. In this configuration, the handlebar mount 100 may be rotated about the handlebars/cylindrical object 610 in order to achieve the desired angular orientation.

FIG. 8 shows an alternative orientation, allowing for a rotating lighting module 210. In this configuration, pins 125 have been replaced with rounded pins 625. Pins 135 are cross-shaped and tend to prevent rotation of lighting module 210. Additionally, geared section 130 interfaces with a corresponding geared portion on the back of lighting module 210, which tends to prevent rotation. In contrast, the geared section 130 on lighting module 210 may interface with tab 820. When lighting module 210 is mounted, tab 820 may fit between the teeth of geared section 130. In order to rotate lighting module 210 up or down, the user turns lighting module 210 about pins 825. Flexible tab arm 810 then may flex, allowing tab 820 to slide over the teeth of geared section 130 of the lighting module's 210 back and into another slot in the geared section 130. In this way, lighting module 210 may be ratcheted and positioned up and down.

The previous detailed description is of a small number of embodiments for implementing the systems and methods for a handlebar mount and is not intended to be limiting in scope. The following claims set forth a number of the embodiments of the systems and methods for a handlebar mount disclosed with greater particularity.

What is claimed:

1. A handlebar mount comprising:
a first side body and a second side body;
a central body, the central body interconnecting the first and second side bodies;
a first elastic portion and a second elastic portion, oriented on the first and second side bodies, respectively; and
a first hook and a second hook, the first and second hooks oriented to receive the first and second elastic portions, respectively, and hold them securely.

2. The handlebar mount of claim 1, wherein each of the first and second side bodies include a semi-circular area.

3. The handlebar mount of claim 2, wherein the first and second elastic portions are oriented to stretch over the semi-circular area of each of the first and second side bodies when the first and second elastic areas are engaged with the first and second hooks.

4. The handlebar mount of claim 3, wherein the handlebar mount has a first configuration and a second configuration when the handlebar mount is placed on handlebars, the first configuration characterized by the first and second elastic portions not engaging the first and second hook, and the second configuration characterized by the first and second elastic portions engaging the first and second hooks, respectively.

5. The handlebar mount of claim 4, wherein in the second configuration, the handlebars are located in the semi-circular area of each of the first and second side bodies, and the first and second elastic portions apply tension to the handlebars, thereby holding the handlebar mount in place.

6. The handlebar mount of claim 4, wherein the first and second hooks are oriented on the central body.

7. The handlebar mount of claim 4, wherein the first and second hooks are oriented on the first and second side bodies, respectively.

8. The handlebar mount of claim 5, wherein a first aperture and a second aperture are located at an end of each of the first and second elastic areas.

9. The handlebar mount of claim 8, wherein each of the first and second side bodies include a pin.

10. The handlebar mount of claim 9, wherein the central body portion includes a geared section.

11. The handlebar mount of claim 10, wherein the pin on the first and second side bodies is cross-shaped and the pin and geared section hold a lighting module in a stationary position in relation to the handlebar mount.

12. The handlebar mount of claim 9, further comprising a lighting module mounted pivotally on the pin on each of the first and second side bodies.

13. The handlebar mount of claim 11, wherein central body includes a flexible tab that interacts with a geared section on the lighting module providing for the lighting module to be held in a variety of rotational positions.

14. The handlebar mount of claim 9, wherein the first and second side bodies are approximately triangularly shaped.

15. The handlebar mount of claim 13, wherein each of the first and second side bodies include a receiver section for receiving an insertable side portion of the central body.

16. The handlebar mount of claim 12, wherein the flexible tab is positioned such that the tab interfaces with the geared section, the flexible tab ratcheting from one groove to another groove of a plurality of grooves of the geared section, and the flexible tab flexing to allow the flexible tab to pass over the protrusions of the geared section.

17. A method of mounting a device on handlebars, the method comprising:
providing a handlebar mount, the mount including:
a first side body and a second side body;
a central body, the central body interconnecting the first and second side bodies;
a first elastic portion and a second elastic portion, oriented on the first and second side bodies, respectively;
a first hook and a second hook, the first and second hooks oriented to receive the first and second elastic portions, respectively, and hold them securely, wherein each of the first and second side bodies include a semi-circular area, and the first and second elastic portions are oriented to stretch over the semi-circular area of each of the first and second side bodies when the first and second elastic areas are engaged with the first and second hooks;
placing the handlebar mount on handlebars, wherein the semi-circular area contacts the handlebars;
stretching the first and second elastic portions around the handlebars to the first and second hooks, respectively, and engaging them with the first and second hooks; and
holding the handlebar mount on the handlebars with tension from the first and second elastic portions.

18. The method of claim 16, wherein the handlebar mount includes a first aperture and a second aperture located at an end of each of the first and second elastic areas;
the method further comprising:
placing the first and second hooks in the first aperture; and
tightening the handlebar mount by stretching the first and second elastic portions to engage the first and second hooks in the second aperture, wherein the second aperture is closer to the first and second elastic portions than the first aperture.

19. The method of claim 17, wherein each of the first and second side bodies include a pin, and the central body portion includes a geared section.

20. The method of claim 17, wherein a lighting module is mounted pivotally on a pin on each of the first and second side bodies.

21. The method of claim 19, further comprising:
rotating the lighting module on the handlebar mount by ratcheting a flexible tab that interacts with a geared area on the back of the lighting module, providing for the lighting module to be held in a variety of rotational positions.
